(19) United States
(12) Patent Application Publication
(10) Pub. No.: US 2016/0381615 A1
(43) Pub. Date: Dec. 29, 2016

(54) ADVANCED HANDOVER PREPARATION FOR A MOBILE DEVICE IN A WIRELESS COMMUNICATION NETWORK

(71) Applicant: QUALCOMM Incorporated, San Diego, CA (US)

(72) Inventors: Sumeeth NAGARAJA, San Diego, CA (US); Vinay JOSEPH, San Diego, CA (US); Damanjit SINGH, San Diego, CA (US)

(21) Appl. No.: 14/750,010

(22) Filed: Jun. 25, 2015

(51) Int. Cl. H04W 36/24; H04W 36/00; H04W 36/14

(52) U.S. Cl. CPC H04W 36/245; H04W 36/14; H04W 36/0061; H04W 36/0088

(57) ABSTRACT

A method of initiating handover preparation of a subset of a plurality of cells in a wireless communication network for a mobile device includes determining a first set of candidate cells of the plurality of cells in the wireless communication network. In one aspect, the method includes obtaining one or more of backhaul performance data, historical mobility data, or historical handover data and adding at least one candidate cell of the first set of candidate cells to the subset of cells based on the one or more data. The method then includes generating and sending a handover request message from the serving cell to each of the cells included in the subset of cells to initiate handover preparation of the mobile device from the serving cell.

### FIELD OF DISCLOSURE

This disclosure relates generally to wireless communications and, in particular but not exclusively, relates to handover preparation of a mobile device from a serving cell in a wireless communication network.

### BACKGROUND

Wireless communication networks are widely deployed to provide various types of communication content such as, voice, data, and so on. Typical wireless communication networks may be multiple-access systems capable of supporting communication with multiple users by sharing available system resources (e.g., bandwidth, transmission power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long-term evolution (LTE), ultra mobile broadband (UMB), evolution data optimized (EV-DO), etc.

Generally, wireless multiple-access communication networks may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations.

To supplement conventional base stations, additional low-power base stations can be deployed to provide more robust wireless coverage to mobile devices. For example, low-power base stations (e.g., which can be commonly referred to as Home NodeBs or Home eNBs, collectively referred to as H(e)NBs, femto nodes, femtocell nodes, pico nodes, micro nodes, etc.) can be deployed for incremental capacity growth, richer user experience, in-building or other specific geographic coverage, and/or the like. Typically, such small-coverage base stations are connected to the Internet and the mobile operator's network via a DSL router or a cable modem.

As a mobile device moves throughout a given geographical area, the mobile device may need to be handed-off from one of the base stations of the wireless communication network to another base station. In such a system, small-coverage base stations may be deployed in an ad-hoc manner. For example, small-coverage base stations may be deployed based on the individual decision of owners that install the base stations. Thus, in a given area there may be a relatively large number of these small-coverage base stations to which the mobile unit may be handed-off. Furthermore, there can be a significant delay between the time a handover request message is sent to a neighboring cell and the time that the neighboring cell acknowledges the request, especially if backhaul quality of the neighboring cell is poor. Consequently, there is a need for effective handoff methods in a wireless communication network employing a large number of base stations and with varying degrees of backhaul performance.

### SUMMARY

Aspects of the present disclosure are directed to a method, an apparatus, an access point, and non-transitory computer-readable medium for initiating handover preparation of a subset of a plurality of cells in a wireless communication network for a mobile device.

In one aspect, a method of initiating handover preparation of a subset of a plurality of cells in a wireless communication network for a mobile device includes determining, by a serving cell of the mobile device, a first set of candidate cells of the plurality of cells in the wireless communication network. The method then includes obtaining, by the serving cell, at least one data, such as backhaul performance data, historical mobility data, and historical handover data and adding at least one candidate cell of the first set of candidate cells to the subset of cells based on the at least one data. The serving cell then generates and sends a handover request message to each of the cells included in the subset of cells to initiate handover preparation of the mobile device from the serving cell.

In yet another aspect, an apparatus is provided for use in a serving cell to initiate handover preparation of a subset of a plurality of cells in a wireless communication network for a mobile device. The apparatus includes memory adapted to store program code and a processing unit coupled to the memory to access and execute instructions included in the program code. In operation, the serving cell determines a first set of candidate cells of the plurality of cells in the wireless communication network, obtains at least one data, such as backhaul performance data, historical mobility data, and historical handover data, and adds at least one candidate cell of the first set of candidate cells to the subset of cells based on the at least one data. The serving cell then generates and sends a handover request message to each cell included in the subset of the plurality of cells to initiate handover preparation of the mobile device from the serving cell.

In still another aspect, an apparatus is provided for use in a serving cell to initiate handover preparation of a subset of a plurality of cells in a wireless communication network for a mobile device. The apparatus includes means for determining, by the serving cell of the mobile device, a first set of candidate cells of the plurality of cells in the wireless communication network. The apparatus also includes means for obtaining, by the serving cell, at least one data such as backhaul performance data, historical mobility data, or historical handover data, means for adding at least on candidate cell of the first set of candidate cells to the subset of the plurality of cells based on the at least one data, and means for generating and sending a handover request message from the serving cell to each of the cells included in the subset of the plurality of cells to initiate handover preparation of the mobile device from the serving cell.

Another aspect includes a non-transitory computer-readable medium for use in a serving cell to initiate handover preparation of a subset of a plurality of cells in a wireless communication network for a mobile device. The medium includes at least one instruction to determine, by the serving cell, a first set of candidate cells of the plurality of cells in the wireless communication network and at least one instruction to obtain, by the serving cell, at least one data, such as backhaul performance data, historical mobility data, or historical handover data. The medium also includes at least one instruction to at least one candidate cell of the first set of candidate cells to the subset of the plurality of cells based on the at least one data, and at least one instruction to generate and send a handover request message from the serving cell to each of the cells included in the subset of the plurality of cells to initiate handover preparation of the mobile device from the serving cell.

### BRIEF DESCRIPTION OF THE DRAWINGS

The accompanying drawings are presented to aid in the description of various aspects of the disclosure and are provided solely for illustration of the aspects and not limitation thereof.

FIG. 1A illustrates an example wireless communication network including multiple base stations where initiating handover preparation is based on backhaul performance data.

FIG. 1B illustrates an example wireless communication network including multiple base stations where initiating handover preparation is based, at least, on historical mobility data.

FIG. 2 illustrates an example wireless communication network including an Access Point (AP) in communication with a mobile device.

FIG. 3A is a flowchart illustrating a process, performed by a serving cell, of initiating handover preparation based on at least one of backhaul performance data, historical mobility data, and historical handover data.

FIG. 3B is a flowchart illustrating an example process of determining a first set of candidate cells in a wireless communication network.

FIG. 4A is a flowchart illustrating a process, performed by a serving cell of initiating handover preparation based on backhaul performance data.

FIG. 4B is a flowchart illustrating an example process of obtaining backhaul performance data, by a serving cell in a wireless communication network.

FIG. 5 is a flowchart illustrating a process, performed by a serving cell, of initiating handover preparation based on historical mobility data.

FIG. 6 is a flowchart illustrating a process, performed by a serving cell, of initiating handover preparation based on historical mobility data and historical handover data.

FIG. 7 is a flowchart illustrating an example process of adding candidate cells to the subset of cells.

FIG. 8 is a flowchart illustrating an example process of handing off a mobile device and then updating historical handover data based on which of the cells the mobile device is handed off to.

FIGS. 9A and 9B are simplified block diagrams illustrating several sample aspects of components that may be employed in an access point apparatus configured to initiate handover preparation in a wireless communication network.

### DETAILED DESCRIPTION

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

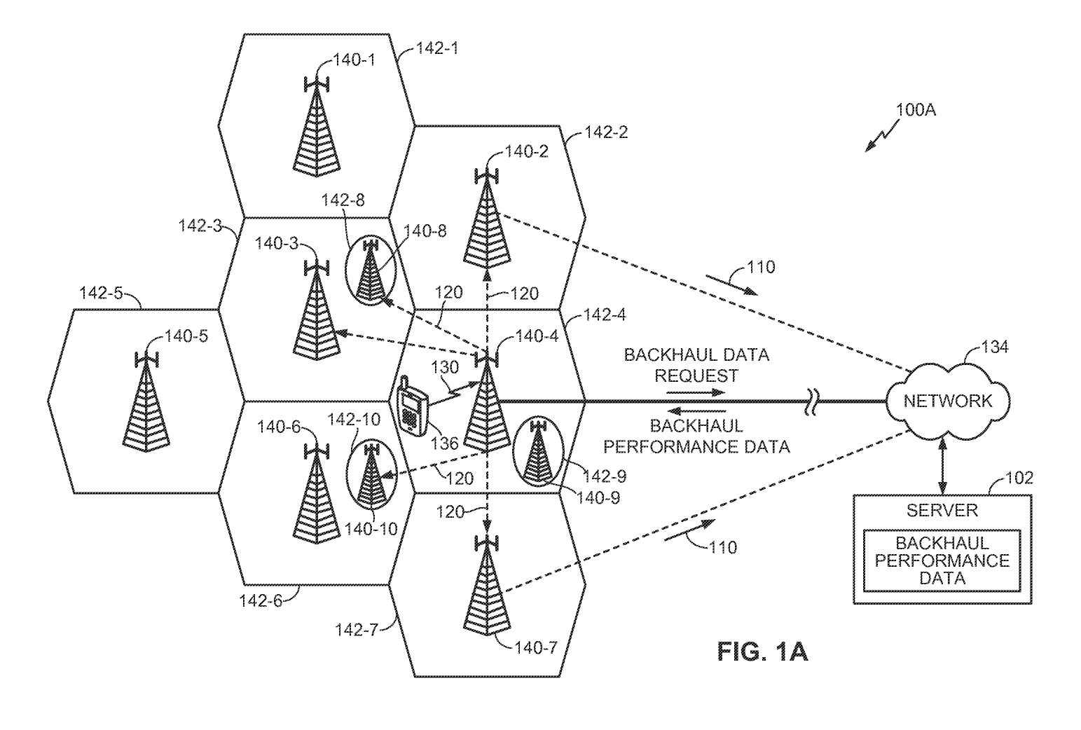

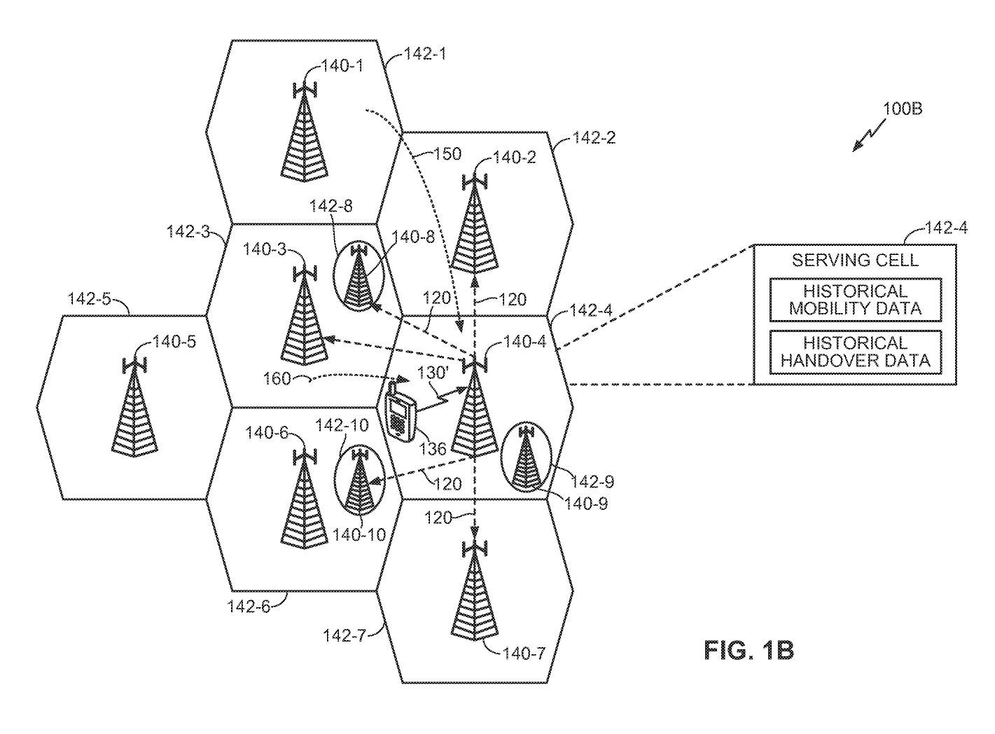

FIG. 1A illustrates an example wireless communication network 100A including multiple base stations where initiating handover preparation is based on backhaul performance data. As shown, wireless communication network 100A includes a network of cells (e.g., 142-1 through 142-10), a network 134, a server 102, and one or more mobile devices 136. The cells (e.g., 142-1 through 142-10) and network 134 enable mobile device 136 to access one or more external networks (not shown), such as the Public Switched Telephone Network (PSTN) or the Internet.

Each cell (e.g., 142-1 through 142-10) includes at least one base station (e.g., 140-1 through 140-10). The base stations (e.g., 140-1 through 140-10) are geographically distributed across the wide geographic area served by the wireless communication network 100A. Each base station (e.g., 140-1 through 140-10) provides wireless coverage for one or more respective portions of that geographic area, referred to as cells (e.g., 142-1 through 142-10). Because of this, mobile device 136 may move within or between cells and may communicate with one or more base stations (e.g., 140-1 through 140-10) at any given position.

Different cells (e.g., 142-1 through 142-10) may have different nominal sizes, depending on the maximum transmit power utilized by the base stations (e.g., 140-1 through 140-10) serving those cells. For example, base station 140-1 may have a relatively large maximum transmit power and correspondingly serves mobile devices 136 within a relatively large cell 142-1, while base station 140-8 may have a relatively small maximum transmit power and correspondingly serves mobile devices 136 within a relatively small cell 142-8. In general, different base stations that have different pre-defined maximum transmit powers (and thereby serve cells of different nominal sizes) belong to different base station classes (e.g., a macro base station class, a micro base station class, a pico base station class, etc.). As used herein, small cells generally refer to a class of low-powered base stations that may include or be otherwise referred to as femto cells, pico cells, micro cells, etc.

The different base stations (e.g., 140-1 through 140-10) of FIG. 1A include seven example macro cell base stations (i.e., 140-1, 140-2, 140-3, 140-4, 140-5, 140-6, and 140-7) and three example small cell base stations (i.e., 140-8, 140-9, and 140-10). For instance, the macro cell base station 140-4 is configured to provide communication coverage within a macro cell coverage area 142-4, which may cover a few blocks within a neighborhood or several square miles in a rural environment. Meanwhile, the small cell base station 140-9 is configured to provide communication coverage within respective small cell coverage area 142-9 with varying degrees of overlap existing among the different coverage areas. In some systems, each cell may be further divided into one or more sectors (not shown).

As shown in FIG. 1A, mobile device 136, at its current position, is served by base station 140-4 in the sense that the mobile device 136 exchanges data with base station 140-4. Base station 140-4 transmits data to mobile device 136 on a particular frequency (referred to as the serving cell frequency) and over a particular bandwidth (known as the serving cell bandwidth). Thus, from the perspective of mobile device 136, base station 140-4 is the serving base station and cell 142-4 is the serving cell. Other cells that are geographically adjacent to, or partially coincident with, the serving cell 142-4 are referred to as neighboring cells. In this example, cells 142-2, 142-3, 142-6, 142-7, 142-8, 142-9, and 142-10 are neighboring cells.

Turning to the illustrated connections in more detail, the mobile device 136 may transmit and receive messages 130 via a wireless link with a macro base station 140-4, the message including information related to various types of communication (e.g., voice, data, multimedia services, associated control signaling, etc.). The mobile device 136 may similarly communicate with a small cell base station 140-9 via another wireless link, and the mobile device 136 may similarly communicate with the small cell base station 140-10 via another wireless link.

As is further illustrated in FIG. 1A, the macro cell base station 140-4 may communicate with network 134, via a wired link or via a wireless link, while the small cell base stations 140-8, 140-9, and 140-10 may also similarly communicate with the network 134, via their own wired or wireless links. For example, the small cell base stations 140-8, 140-9, and 140-10 may communicate with the network 134 by way of an Internet Protocol (IP) connection, such as via a Digital Subscriber Line (DSL, e.g., including Asymmetric DSL (ADSL), High Data Rate DSL (HDSL), Very High Speed DSL (VDSL), etc.), a TV cable carrying IP traffic, a Broadband over Power Line (BPL) connection, an Optical Fiber (OF) cable, a satellite link, or some other link.

The network 134 may include any type of electronically connected group of computers and/or devices, including, for example, Internet, Intranet, Local Area Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 134 includes network variations such as the public Internet, a private network within the Internet, a secure network within the Internet, a private network, a public network, a value-added network, an intranet, and the like. In certain systems, the network 134 may also comprise a Virtual Private Network (VPN).

Accordingly, it will be appreciated that the macro cell base stations (i.e., 140-1, 140-2, 140-3, 140-4, 140-5, 140-6, and 140-7) and/or the small cell base stations (i.e., 140-8, 140-9, and 140-10) may be connected to the network 134 using any of a multitude of devices or methods. These connections may be referred to as the “backbone” or the “backhaul” of the network, and may in some implementations be used to manage and coordinate communications among and between the macro cell base stations (i.e., 140-1, 140-2, 140-3, 140-4, 140-5, 140-6, and 140-7) and the small cell base stations. In this way, as a mobile device 136 moves through such a mixed communication network environment that provides both macro cell and small cell coverage, the mobile device 136 may be served in certain locations by macro cell base stations (i.e., 140-1, 140-2, 140-3, 140-4, 140-5, 140-6, and 140-7), at other locations by small cell base stations (i.e., 140-8, 140-9, and 140-10), and, in some scenarios, by both macro cell and small cell base stations (e.g., 140-1 through 140-10).

The illustrated wireless communication network 100A is a multiple-access system that is divided into a plurality of cells (e.g., 142-1 through 142-10) and configured to support communication for a number of mobile devices 136. Communication coverage in each of the cells (e.g., 142-1 through 142-10) is provided by a corresponding base station (e.g., 140-1 through 140-10), which interacts with one or more mobile devices 136 via DownLink (DL) and/or UpLink (UL) connections. In general, the DL corresponds to communication from a base station to a mobile device, while the UL corresponds to communication from a user device to a base station.

For their wireless air interfaces, each base station may operate according to one of several radio access technologies (RATs) depending on the network in which it is deployed. These networks may include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a RAT such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a RAT such as Global System for Mobile Communications (GSM). An OFDMA network may implement a RAT such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication network (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

As will be described in more detail below, one or more of the base stations (e.g., 140-1 through 140-10) may be configured in accordance with the teachings herein to provide or otherwise support the initialization of handover preparation of mobile device 136 from a serving cell to a neighboring cell. For example, base station 140-4 may send handover request messages 120 to a subset of neighboring cells based on backhaul performance data that indicates the current backhaul performance of each neighboring cell. In one aspect, the subset of neighboring cells is selected based on which cells have a backhaul performance that is less than a performance threshold. Thus, cells with poor or low backhaul performance may be given additional time to reply with a handover acknowledgement or otherwise prepare for a handover of mobile device 136.

In some aspects, the backhaul performance data includes performance metrics like round trip delay, latency, throughput, bandwidth, and jitter or variation in aforementioned metrics. Furthermore, these performance metrics may be evaluated for the communication with a common entity (e.g., a server 102 in the network, or a web server in or coupled to the network 134). Also, these performance metrics may be evaluated for each cell in the list of candidate cells by monitoring the messages exchanged with the candidate cells in the past.

As shown in FIG. 1A, wireless communication network 100A may include one or more servers 102 to perform or otherwise aide in the initialization of the handover preparation of a subset of the cells. For example, server 102 may, either upon request or periodically, receive backhaul performance data from each of the cells (e.g., 142-1 through 142-10) included in wireless communication network 100A. As will be described in more detail below, a serving cell (e.g., cell 142-4) may then send a backhaul data request to server 102 for the backhaul performance data of one or more of the neighboring cells, and then use the received backhaul performance data to select a subset of cells to initiate handover preparation.

As used herein, the terms “mobile device” and “base station” are not intended to be specific or otherwise limited to any particular Radio Access Technology (RAT), unless otherwise noted. In general, such mobile devices may be any wireless communication device (e.g., a mobile phone, router, personal computer, server, etc.) used by a user to communicate over a communications network, and may be alternatively referred to in different RAT environments as an Access Terminal (AT), a Mobile Station (MS), a Subscriber Station (STA), a User Equipment (UE), etc. Similarly, a base station may operate according to one of several RATs in communication with user devices depending on the network in which it is deployed, and may be alternatively referred to as an Access Point (AP), a Network Node, a NodeB, an evolved NodeB (eNB), etc. In addition, in some systems a base station may provide purely edge node signaling functions while in other systems it may provide additional control and/or network management functions.

FIG. 1B illustrates an example wireless communication network 100B including multiple base stations where initiating handover preparation is based, at least, on historical mobility data. Wireless communication network 100B is similar to wireless communication network 100A of FIG. 1A, where like elements are labeled with like numerals. Thus, wireless communication network 100B is a multi-access wireless communication network having multiple cells (e.g., 142-1 through 142-10) of different nominal sizes.

As with the wireless communication network 100A of FIG. 1A, one or more of the cell base stations (e.g., 140-1 through 140-10) of wireless communication network 100B may be configured in accordance with the teachings herein to provide or otherwise support the initialization of handover preparation of mobile device 136 from a serving cell to a neighboring cell. However, base station 140-4 may send handover request messages 120 to a subset of neighboring cells (e.g., 142-1 through 142-10) based on historical mobility data and/or historical handover data. In one aspect, historical mobility data and/or historical handover data may indicate which of the neighboring cells the mobile device 136 is likely to be handed off to. Thus, a serving cell may use this data in determining which cells (e.g., 142-1 through 142-10) to initiate handover preparation. By way of example, mobile device 136 may provide, via a message 130′, its own historical mobility data to the serving cell 142-4. The historical mobility data may indicate which of the cells (e.g., 142-1 through 142-10) have previously served mobile device 136. In addition, the historical mobility data may indicate an amount of time that the mobile device 136 was previously served by each of the cells (e.g., 142-1 through 142-10). In another aspect, the historical mobility data may be obtained through a message exchange between cells (e.g., 142-1 through 142-10) during handover. For example, a source cell of a handover may append its mobility data to the historical data mobility data of the mobile device 136 and send this information to the target cell of the handover (which then does the same during the next handover).

In addition to the historical mobility data received from mobile device 136, each serving cell may maintain its own historical handover data to use in determining which neighboring cells to initiate handover preparation. For example, serving cell 142-4 may store and maintain historical handover data for specific mobile device 136 that indicates which neighboring cells (e.g., 142-1 through 142-10) serving cell 142-4 has previously handed off mobile device 136 to, as well as the number of instances that serving cell 142-4 has handed off mobile device 136 to that neighboring cell (e.g., 142-1 through 142-10).

Based on the historical mobility data and/or the historical handover data, a serving cell may identify handover patterns in the mobile device 136 mobility between cells (e.g., 142-1 through 142-10). For example, in one embodiment, serving cell 142-4 may determine, based on the historical handover data, that mobile device 136 was previously handed over from serving cell 142-4 to neighboring cell 142-9 at least a threshold percentage (e.g., 95%) of the time and thus, serving cell 142-4 may initiate handover preparation for neighbor cell 142-9. These and other aspects will be described in further detail below.

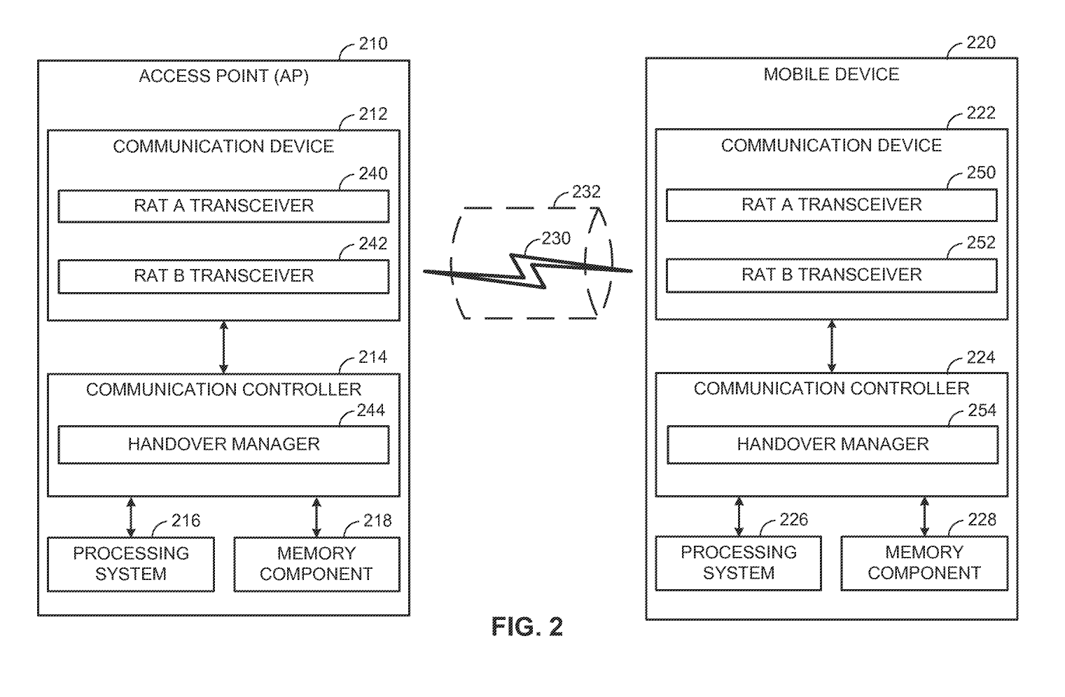

FIG. 2 illustrates an example wireless communication network including an Access Point (AP) 210 in communication with mobile device 220. AP 210 is one possible implementation of base stations 140-4 or 140-9 of FIGS. 1A and 1B, while mobile device 220 is one possible implementation of mobile device 136 of FIGS. 1A and 1B. Unless otherwise noted, the terms “mobile device” and “access point” are not intended to be specific or limited to any particular Radio Access Technology (RAT). In general, mobile device 220 may be any wireless communication device allowing a user to communicate over a communications network (e.g., a mobile phone, router, personal computer, server, entertainment device, Internet of Things (JOT)/Internet of Everything (JOE) capable device, in-vehicle communication device, etc.), and may be alternatively referred to in different RAT environments as a User Device (UD), a Mobile Station (MS), a Subscriber Station (STA), a User Equipment (UE), etc. Similarly, AP 210 may operate according to one or several RATs in communicating with mobile devices depending on the network in which the access point is deployed, and may be alternatively referred to as a Base Station (BS), a Network Node, a NodeB, an evolved NodeB (eNB), etc. Such an access point may correspond to a small cell access point, for example. “Small cells” generally refer to a class of low-powered access points that may include or be otherwise referred to as femto cells, pico cells, micro cells, Wi-Fi APs, other small coverage area APs, etc. Small cells may be deployed to supplement macro cell coverage, which may cover a few blocks within a neighborhood or several square miles in a rural environment, thereby leading to improved signaling, incremental capacity growth, richer user experience, and so on.

In the example of FIG. 2, AP 210 and mobile device 220 each generally include a wireless communication device (represented by the communication devices 212 and 222) for communicating with other network nodes via at least one designated RAT types. The communication devices 212 and 222 may be variously configured for transmitting and encoding signals (e.g., messages, indications, information, and so on), and, conversely, for receiving and decoding signals (e.g., messages, indications, information, pilots, and so on) in accordance with the designated RAT. AP 210 and mobile device 220 may also each generally include a communication controller (represented by the communication controllers 214 and 224) for controlling operation of their respective communication devices 212 and 222 (e.g., directing, modifying, enabling, disabling, etc.). The communication controllers 214 and 224 may operate at the direction of or otherwise in conjunction with respective host system functionality (illustrated as the processing systems 216 and 226 and the memory components 218 and 228). In some designs, the communication controllers 214 and 224 may be partly or wholly subsumed by the respective host system functionality.

Turning to the illustrated communication in more detail, mobile device 220 may transmit and receive messages via a wireless link 230 with the AP 210, where the messages include information related to various types of communication (e.g., voice, data, multimedia services, associated control signaling, connection setup procedures, etc.). The wireless link 230 may operate over a communication medium of interest, shown by way of example in FIG. 2 as the medium 232, which may be shared with other communications as well as other RATs. A medium 232 of this type may be composed of one or more frequency, time, and/or space communication resources (e.g., encompassing one or more channels across one or more carriers) associated with communication between one or more transmitter/receiver pairs, such as the AP 210 and mobile device 220.

As a particular example, medium 232 may correspond to at least a portion of an unlicensed frequency band shared with other RATs. In general, the AP 210 and mobile device 220 may operate via wireless link 230 according to one or more RATs depending on the network in which they are deployed. These networks may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks, in particular those employing small cell access points, have extended operation into unlicensed frequency bands such as the Unlicensed National Information Infrastructure (U-NII) band used by Wireless Local Area Network (WLAN) technologies, most notably IEEE 802.11x WLAN technologies generally referred to as “Wi-Fi.”

In the example of FIG. 2, the communication device 212 of the AP 210 includes two co-located transceivers operating according to respective RAT types, including a “RAT A” transceiver 240 and a “RAT B” transceiver 242. As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a Wi-Fi chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

The RAT A transceiver 240 and the RAT B transceiver 242 may be of different RAT types, may provide different functionalities, and may be used for different purposes. As an example, the RAT A transceiver 240 may operate in accordance with Long Term Evolution (LTE) technology to provide communication with mobile device 220, while the RAT B transceiver 242 may operate in accordance with Wi-Fi technology to monitor Wi-Fi signaling on the medium 232. The communication device 222 of mobile device 220 includes similar RAT A transceiver 250 of a first RAT type (e.g., LTE) and a RAT B transceiver 252 of a second RAT type (Wi-Fi).

As mentioned above, a mobile device may need to be handed-off from a current serving base station (e.g., AP) to another base station (e.g., AP). However, there may be a relatively large number of base stations in the wireless communication network to which the mobile unit may be handed-off. Furthermore, there can be a significant delay between the time a handover request message is sent to a neighboring cell and the time that the neighboring cell acknowledges the request, especially if backhaul quality of the neighboring cell is poor.

Accordingly, embodiments discussed herein provide for an advance handover preparation by determining a subset of cells for which to send handover request messages to. That is, rather than send handover request messages to each neighboring cell, a serving cell in accordance with the teachings herein may send a handover request message to less than all the neighboring cells, and in some cases may only send the handover request message to a single neighboring cell. In the illustrated example of FIG. 2, AP 210 includes a handover manager 244 for determining which of the candidate neighboring cells to add to a subset of cells. Then, under direction of the handover manager 244, RAT A transceiver 240 may send (e.g., transmit) handover request messages to each of the cells included in the subset of cells.

In one aspect, handover manager 244 may add candidate neighboring cells to the subset of cells based on obtained backhaul performance data. For example, if a candidate neighboring cell has a backhaul performance that is below a performance threshold it may be added to the subset of cells to initiate handover preparation.

In another aspect, handover manager 244 may add candidate neighboring cells based on historical mobility data and or historical handover data. In yet another aspect, handover manager 244 may add candidate neighboring cells to the subset of cells based on at least one of dynamically identified handover patterns or one or more stored handover patterns that are maintained at the serving cell (e.g., AP 210). Thus, handover manager 244 may identify one or more identified handover patterns in the mobility of mobile device 220 between cells. For example, in one embodiment, for each candidate neighboring cell, handover manager 244 may determine a number of instances that mobile device 220 was previously handed off to the candidate neighboring cell from AP 210. If the number of instances is above a threshold percentage (e.g., 95%) of the total handovers for mobile device 220 from AP 210, then handover manager 244 may add the candidate cell to the subset of cells to initiate handover preparation.

In one aspect, identifying one or more identified handover patterns in mobility of mobile device 220 may include identifying a first sequence of previous serving cells (e.g., P_{M}, P_{M-1}, . . . P₁) of the mobile device 220 from the historical mobility data. The identifying of the one or more identified handover patterns may then include identifying cells from the stored historical handover data that were selected for handover a threshold number of times for sequences that match the first sequence (e.g., P_{M}, P_{M-1}, . . . P₁). For example, referring back to FIG. 1B, the historical mobility data of mobile device 136 may indicate a sequence 150 of serving cells that previously served mobile device 136. That is, the sequence 150 may indicate that mobile device 136 was previously severed by cell 142-1, then by cell 142-2, then by current serving cell 142-4, in that order. Thus, the sequence 150 may be represented as cells 142-1->142-2->142-4. Accordingly, the current serving cell 142-4 may identify, from the stored historical handover data, sequences that match the sequence 150 of the mobile device 136 (i.e., 142-1->142-2->142-4). In one example, the stored historical handover data includes historical handover data with regards to the specific mobile device 136, as well as other mobile devices included in wireless communication network 100B. From these matching sequences included in the historical handover data, the current serving cell 142-4 may then determine which neighboring cell was selected for a subsequent handover for each of these matching sequences. For example, if the matching sequences (i.e., 142-1->142-2->142-4), included in the historical handover data, indicate a subsequent handover to cell 142-7 for a threshold percentage (e.g., 95%) of handovers from cell 142-4, then cell 142-4 may add the cell 142-7 to the subset of cells to initiate handover preparation.

If the number of previous serving cells of the mobile device 220 is one (e.g., M=1), then using stored historical handover data may include identifying the mobile device's 220 previous cell from the historical mobility history of the mobile device 220 or from handover messages. In this example, using the stored historical handover data may include identifying cells from the stored historical handover data that were selected above a percentage threshold as target for handover when the mobile device 220 came from the identified cell. For example, referring again back to FIG. 1B, the historical mobility data 160 of mobile device 136 may indicate only a single previous serving cell (i.e., cell 142-3). Thus, the current serving cell 142-4 may identify, from the stored historical handover data, which of the neighboring cells were selected for a subsequent handover when specific mobile device 136, or other mobile devices, came from cell 142-3. Of these identified cells that were selected for subsequent handover when the mobile device came from cell 142-3, if a threshold percentage indicate a handover to a particular neighboring cell, such as cell 142-9, then current serving cell 142-4 may add cell 142-9 to the subset of cells to initiate handover preparation.

If however, the historical mobility data of the mobile device indicates no previous serving cells (e.g., M=0), then using the historical handover data may include identifying cells from the stored historical handover data that were selected above a percentage threshold as target for handover for outgoing handovers from the current serving cell. By way of example, referring again back to FIG. 1B, the historical mobility data of mobile device 136 may be empty, indicating no previous serving cells (e.g., mobile device 136 was turned on or activated while located in cell 142-4). Thus, the current serving cell 142-4 may identify, from the stored historical handover data, which of the neighboring cells were selected for a subsequent handover from current serving cell 142-4. Of these identified cells that were selected for subsequent handover from current serving cell 142-4, if a threshold percentage indicate a handover to a particular neighboring cell, such as cell 142-6, then current serving cell 142-4 may add cell 142-6 to the subset of cells to initiate handover preparation.

In one aspect, the one or more identified handover patterns may be stored and/or maintained locally at the serving cell (e.g., AP 210). For example, the AP 210 may locally maintain stored handover patterns in memory component 218, previously identified by AP 210, or otherwise obtained by AP 210. Under direction of a handover manager 254 included in communication controller 224 of mobile device 220, the mobile device 220 is then handed off to one of the candidate neighboring cells. After completion of a hand off of the mobile device 220, the handover manager 244 may then update the stored handover patterns based on which cell the mobile device is handed off to. In one example, updating the stored handover patterns may include adding a newly identified handover pattern to the stored handover patterns. In another example, updating the stored handover patterns may include updating an existing stored handover pattern based on which cell the mobile device is handed off to.

Accordingly, handover manager 244 may determine a subset of cells for which to send handover request messages to for advance handover preparation based on (1) an identified handover pattern, itself; (2) historical mobility data, itself; (3) historical handover data, itself; (4); a stored handover pattern, itself; (5) backhaul performance data, itself; or (6) any combinations of one or more of the above.

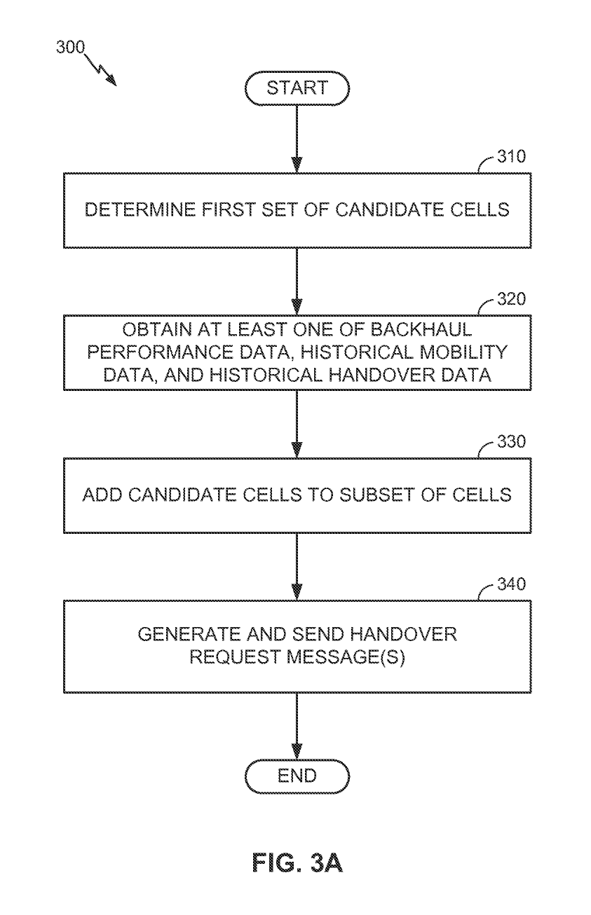

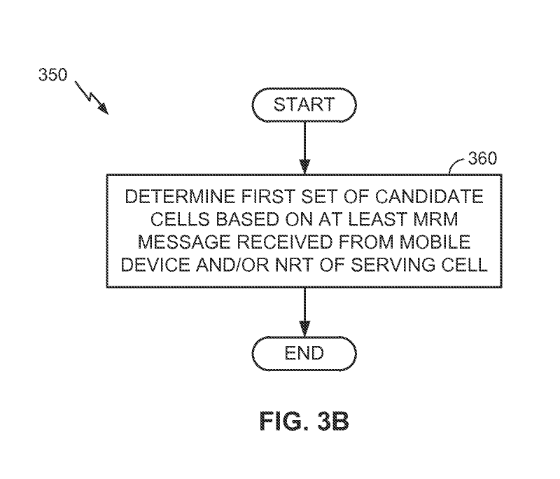

FIG. 3A is a flowchart illustrating a process 300, performed by a serving cell, of initiating handover preparation based on at least one of backhaul performance data, historical mobility data, or historical handover data. Process 300 may be performed by any of the cells (e.g., 142-1 through 142-10) (via base stations 140-1 through 140-10) of FIG. 1A and/or AP 210 of FIG. 2. Process 300 will be described with reference to FIGS. 1A, 3A, and 3B.

As described above with reference to FIG. 1A, mobile device 136 is currently served by cell 142-4 and thus cell 142-4 is the current serving cell of mobile device 136. Therefore, in process block 310, the handover manager (e.g., handover manager 244) of the serving cell 142-4 determines a first set of candidate cells in the wireless communication network 100A.

Turning now to FIG. 3B, a flowchart is shown illustrating an example process 350 of determining the first set of candidate cells in the wireless communication network 100A. That is, process 350 is one possible implementation of process block 310. In process block 360 of FIG. 3B, serving cell 142-4 receives the message 130 (e.g., a measurement report message (MRM)) from mobile device 136. The received message 130 from mobile device 136 may identify a first set of candidate cells (e.g., the neighboring cells seen by mobile device 136) as well as the received signal strength (RSS) of each. In one embodiment, serving cell 142-4 and/or mobile device 136 may exclude neighboring cells from the first set of candidate cells if the received signal strength is below a RSS threshold.

In another aspect, process block 360 may include serving cell 142-4 determining the first set of candidate cells by adding cells to the first set that are included in a neighbor relation table (NRT) of the serving cell 142-4. In one example, the NRT is automatically managed by the serving cell 142-4 based on measurements of detected cells provided by various user devices and/or by the base stations themselves.

Referring back to FIG. 3A, process block 320 then includes obtaining at least one of: backhaul performance data, historical mobility data, and historical handover data. In one aspect, the backhaul performance data may indicate a backhaul performance of each of the candidate cells included in the first set of candidate cells, determined in process block 310. The historical mobility data may indicate which of the cells of wireless communications network 100A have previously served the mobile device 136. The historical handover data may indicate a number of instances that the mobile device 136 or other mobile devices were previously handed off to each respective candidate cell of the first set of candidate cells, determined in process block 310.

Next, in process block 330, the handover manager of the serving cell 142-4 then adds at least one candidate cell of the first set of candidate cells to a subset of cells based on at least one of the backhaul data, the historical mobility data, and the historical handover data. In process block 340, the handover manager of the serving cell 142-4 then generates and sends a handover request message 120 to each of the candidate cells included in the subset of cells to initiate advanced handover preparation of the mobile device from the serving cell.

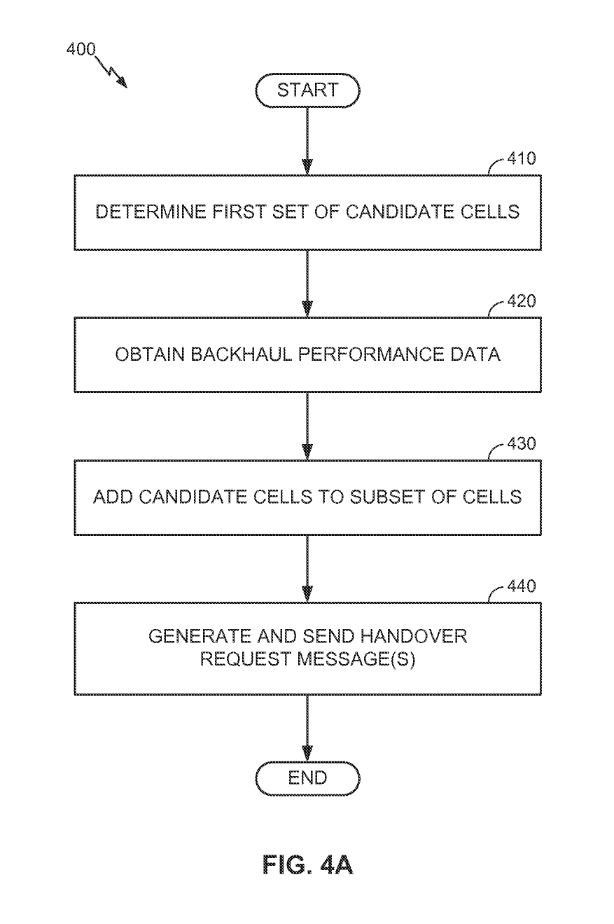

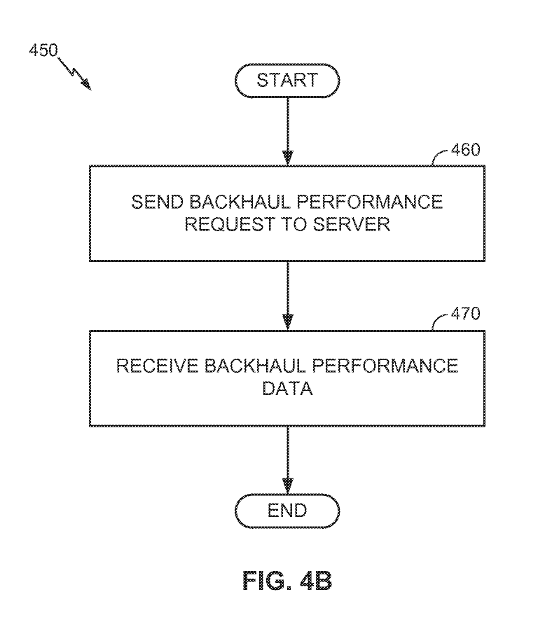

FIG. 4A is a flowchart illustrating a process 400, performed by a serving cell, of initiating handover preparation based on backhaul performance data. Process 400 is one possible implementation of process 300 of FIG. 3A and may be performed by any of the cells (e.g., 142-1 through 142-10) (via base stations 140-1 through 140-10) of FIG. 1A and/or AP 210 of FIG. 2. Process 400 will be described with reference to FIGS. 1A, 4A, and 4B.

In process block 410, serving cell 142-4 determines a first set of candidate cells in the wireless communication network 100A, similar as described above with reference to process block 310 of process 300. Process block 420 then includes obtaining backhaul performance data for each of the candidate cells included in the first set of candidate cells. Turning now to FIG. 4B, process 450 is one possible implementation of process block 420 for obtaining backhaul performance data by a serving cell in the wireless communication network 100A. As described above, server 102 may, either upon request or periodically, receive backhaul performance data 110 from each of the cells included in the wireless communication network 100A.

Thus, in process block 460, serving cell 142-4 may then send a backhaul data request to server 102 for the backhaul performance data of one or more of the candidate cells. In response, server 102 sends, and serving cell 142-4 receives, the most recent backhaul performance data (i.e., process block 470). In one embodiment, in addition to, or in lieu of sending backhaul data requests from serving cell 142-4, server 102 may periodically push backhaul performance data down to one or more of the serving cells. That is, serving cell 142-4 may receive periodic updates from server 102 that include current backhaul performance data of one or more of the neighboring cells of serving cell 142-4.

In one example, each serving cell of wireless communication network 100A may be configured to send updated backhaul performance data 110 to server 102 when a change in its backhaul performance is detected. By way of example, base station 140-9 of cell 142-9 may detect a drop in bandwidth or response time in its backhaul link to network 134 and in response thereto, send its updated backhaul performance data 110 to server 102.

Next, referring back to process 400 of FIG. 4, in process block 430, the serving cell 142-4 then adds at least one candidate cell of the first set of candidate cells to a subset of cells if their respective backhaul performance data indicates backhaul performance that is below a performance threshold. In one embodiment, a backhaul performance that is below a performance threshold may indicate a respective candidate cell has a slow response time and/or low bandwidth. In process block 440, the serving cell 142-4 then generates and sends a handover request message 120 to each of the cells included in the subset of cells to initiate advanced handover preparation of the mobile device from the serving cell.

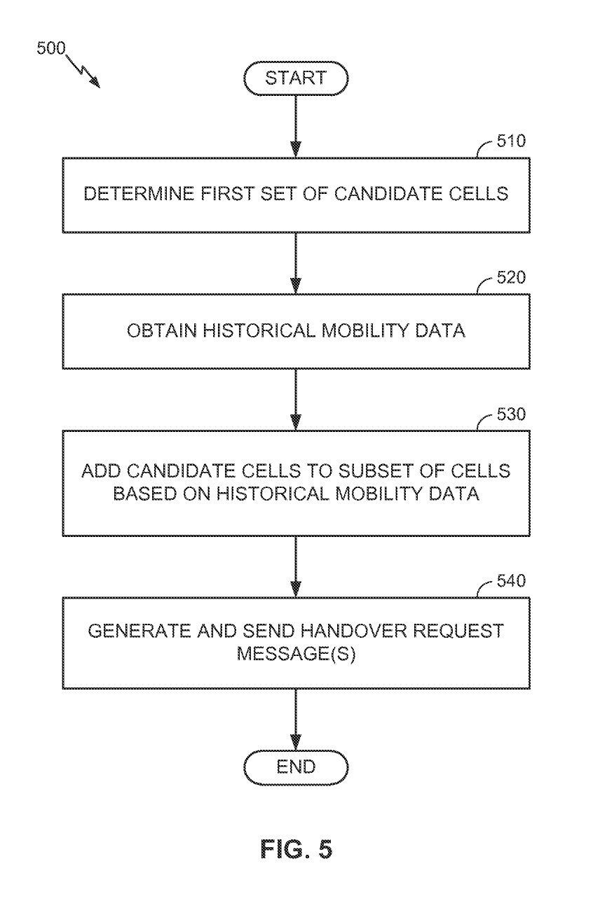

FIG. 5 is a flowchart illustrating a process 500, performed by a serving cell, of initiating handover preparation based on historical mobility data. Process 500 is one possible implementation of process 300 of FIG. 3A and may be performed by any of the cells (e.g., 142-1 through 142-10) (via base stations 140-1 through 140-10) of FIG. 1B and/or AP 210 of FIG. 2. Process 500 will be described with reference to FIGS. 1B, 3B and 5.

Similar to process 300 described above, mobile device 136 is currently served by cell 142-4 and thus cell 142-4 is the current serving cell of mobile device 136. Therefore, in process block 510, serving cell 142-4 determines a first set of candidate cells in the wireless communication network 100B. Process 350 of FIG. 3B is one possible implementation of process block 510.

Next, in process block 520, serving cell 142-4 obtains historical mobility data of mobile device 136. In one aspect, the received historical mobility data indicates which of the cells of wireless communication network 100B have previously served mobile device 136. In another aspect, the received historical mobility data may also indicate an amount of time that the mobile device 136 was previously served by one or more of the cells in wireless communication network 100B. As shown in FIG. 1B, the historical mobility data is received at serving cell 142-4 via a message 130′.

Next, in process block 530, of process 500, the serving cell 142-4 then adds at least one candidate cell of the first set of candidate cells to the subset of cells based on the received historical mobility data. In one embodiment, serving cell 142-4 may identify one or more identified handover patterns in the mobility of mobile device 136 between cells based on the received historical mobility data. For example, a candidate cell may be added to the subset of cells if the candidate cell previously served the mobile device 136 a higher number of instances and/or for longer periods of time relative to other candidate cells. In process block 540, the serving cell 142-4 then generates and sends a handover request message 120 to each of the cells included in the subset of cells to initiate handover preparation of the mobile device 136 from the serving cell.

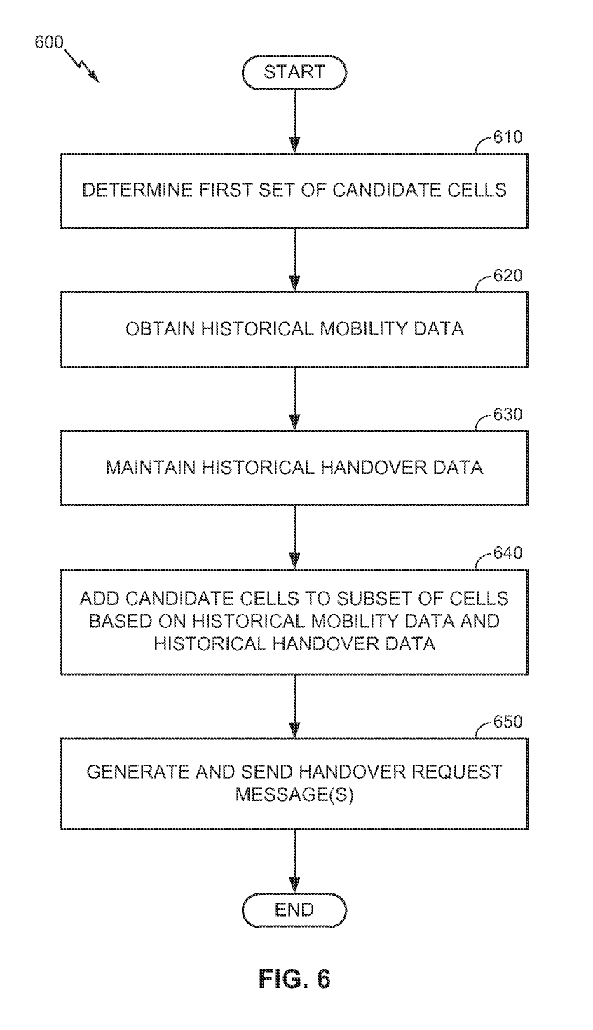

FIG. 6 is a flowchart illustrating a process 600, performed by a serving cell, of initiating handover preparation based on historical mobility data and historical handover data. Process 600 is one possible implementation of process 300 of FIG. 3A, and may be performed by any of the cells (e.g., 142-1 through 142-10) (via base stations 140-1 through 140-10) of FIG. 1B and/or AP 210 of FIG. 2. Process 600 will be described with reference to FIGS. 1B, 3B, 6, and 7.

Similar to process 500 described above, mobile device 136 is currently served by cell 142-4 and thus cell 142-4 is the current serving cell of mobile device 136. Therefore, in process block 610, serving cell 142-4 determines a first set of candidate cells in the wireless communication network 100B. Process 350 of FIG. 3B is one possible implementation of process block 610.

Next, in process block 620, serving cell 142-4 obtains historical mobility data of mobile device 136. As described above, the received historical mobility data may indicate which of the cells of wireless communication network 100B have previously served mobile device 136. In addition, process 600 includes process block 630 of locally maintaining historical handover data at the serving cell 142-4. In one aspect, the historical handover data maintained at the serving cell indicates a number of instances that the mobile device 136 was handed off to each of the neighboring cells from the serving cell. For example, serving cell 142-4 may maintain a count of the number of times that mobile device 136 was handed off from serving cell 142-4 to neighboring cell 142-9, a count of the number of times that mobile device 136 was handed off from serving cell 142-4 to neighboring cell 142-7, and so on.

Next, in process block 640, of process 600, the serving cell 142-4 then adds at least one candidate cell of the first set of candidate cells to the subset of cells based on the received historical mobility data and/or the locally maintained historical handover data. In one embodiment, serving cell 142-4 may identify one or more handover patterns in the mobility of mobile device 136 between cells based on the received historical mobility data and/or historical handover data.

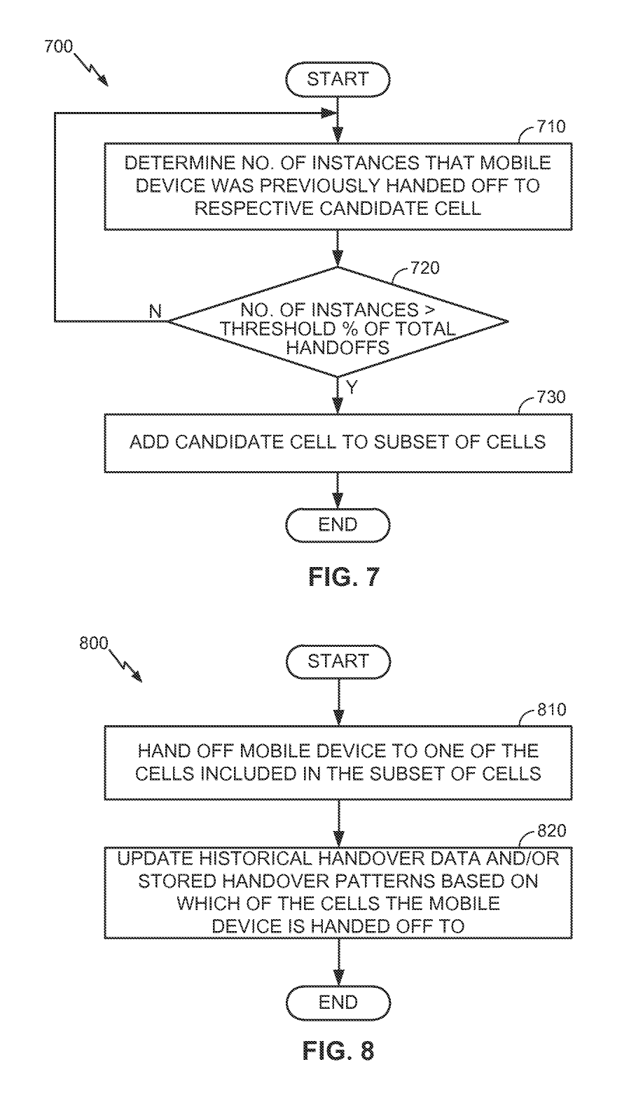

Turning now to FIG. 7, process 700 is one possible implementation of process block 640. In process block 710, serving cell 142-4 determines, based on the historical handover data, the number of instances that mobile device 136 was previously handed off to a respective candidate cell. In decision block 720, it is determined whether the number of instances is greater than a threshold percentage (e.g., 95%) of the total handoffs of mobile device 136 from serving cell 142-4. If so, the process 700 proceeds to process block 730 where the candidate cell is added to the subset of cells. If the number of instances is not greater than the threshold percentage then the candidate cell is not added to the subset of cells and process 700 may return to process block 710 to analyze the historical handover data of a next candidate cell under consideration. In one aspect, the handover pattern(s) identified may be stored and/or updated locally at serving cell 142-4.

Returning now to process 600 of FIG. 6, in process block 650, the serving cell 142-4 then generates and sends a handover request message 120 to each of the cells included in the subset of cells to initiate handover preparation of the mobile device 136 from the serving cell.

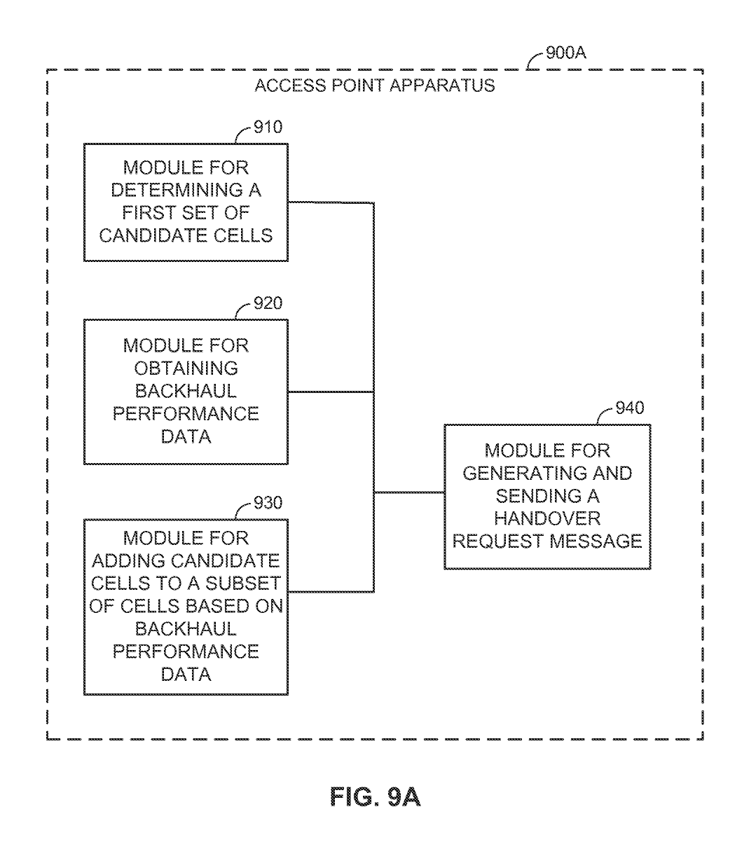

FIG. 8 is a flowchart illustrating an example process 800 of handing off a mobile device 136 and then updating historical handover data and/or stored handover patterns based on which of the cells the mobile device 136 is handed off to. Process 800 is one possible process performed by a serving cell in addition to process 600 of FIG. 6. More specifically, after completion of sending the handover request messages (and after receiving handover request acknowledgement messages), process block 810 may include handing off the mobile device 136 from serving cell 142-4 to a neighboring cell (e.g., 142-9).

Upon completion of the hand off, process block 820 includes the serving cell 142-4 updating the locally maintained historical handover data and/or stored handover patterns. For example, as mentioned above the historical handover data may include a count of the number of times that mobile device 136 was handed off from serving cell 142-4 to neighboring cell 142-9. Thus, process block 820 may include incrementing the handover count of neighboring cell 142-9 corresponding to mobile device 136.

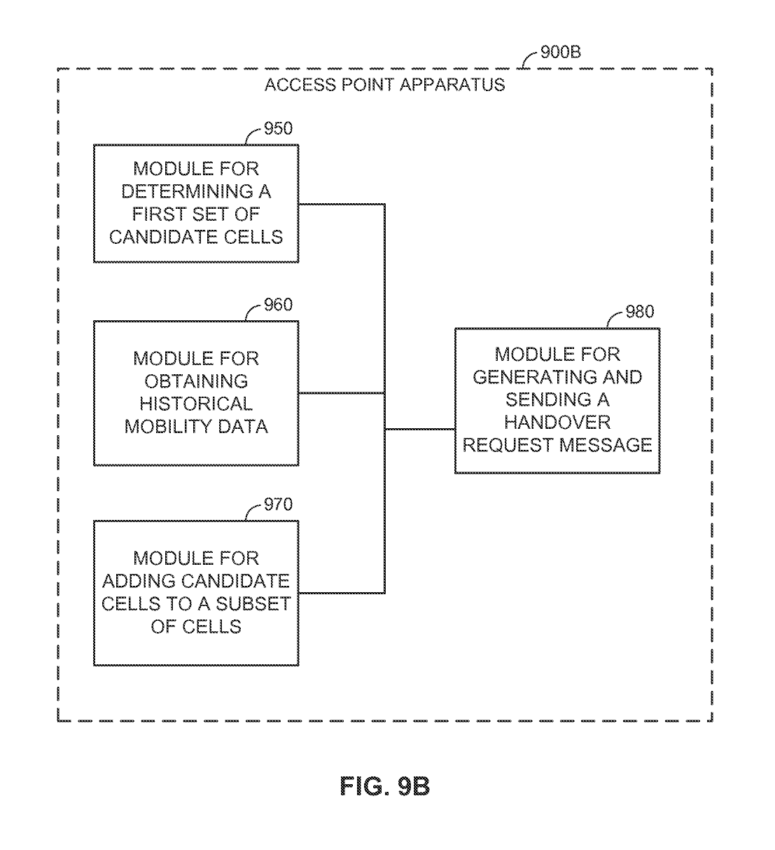

FIGS. 9A and 9B are simplified block diagrams illustrating several sample aspects of components that may be employed in an access point apparatus configured to initiate handover preparation in a wireless communication network.

FIG. 9A is a simplified block diagram illustrating several sample aspects of components that may be employed in an access point apparatus 900A configured to support the initialization of handover preparation as taught herein. Access point apparatus 900A is one possible implementation of any of the base stations (e.g., 140-1 through 140-10) of FIGS. 1A and 1B and/or AP 210 of FIG. 2, represented as a series of interrelated functional modules.

A module 910 for determining a first set of candidate cells may correspond at least in some aspects to, for example, a communication device or a component thereof as discussed herein (e.g., the RAT A transceiver 240 or the like) for receiving a message (e.g., MRM) from a mobile device identifying the first set of candidate cells. Module 920 for obtaining backhaul performance data may also correspond at in some aspects to a communication device, such as communication device 212 for receiving backhaul performance data from a server, such as server 102 of FIG. 1A. Module 930 for adding candidate cells to a subset of cells based on backhaul performance data may correspond to a communication controller including a handover manager, such as handover manager 244 of FIG. 2. Lastly, module 940 may correspond again to a communication device, such as RAT A transceiver 240 for generating and sending one or more handover request messages to the neighboring cells included in the subset of cells.

FIG. 9B is a simplified block diagram illustrating several sample aspects of components that may be employed in an access point apparatus 900B configured to support the initialization of handover preparation as taught herein. Access point apparatus 900B is one possible implementation of any of the base stations (e.g., 140-1 through 140-10) of FIGS. 1A and 1B and/or AP 210 of FIG. 2, represented as a series of interrelated functional modules.

A module 950 for determining a first set of candidate cells may correspond at least in some aspects to, for example, a communication device or a component thereof as discussed herein (e.g., the RAT A transceiver 240 or the like) for receiving a message (e.g., MRM) from a mobile device identifying the first set of candidate cells. Module 960 for obtaining historical mobility data may also correspond in some aspects to a communication device, such as RAT A transceiver 240 for receiving historical mobility data from a mobile device, such as mobile device 136 of FIG. 1B. Module 970 for adding candidate cells to a subset of cells based on historical mobility data may correspond to a communication controller including a handover manager, such as handover manager 244 of FIG. 2. Lastly, module 980 may correspond again to a communication device, such as RAT A transceiver 240 for generating and sending one or more handover request messages to the neighboring cells included in the subset of cells.

The functionality of the modules of FIGS. 9A and 9B may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 9A and 9B, as well as other components and functions described herein, may be implemented using any suitable means. Such means also may be implemented, at least in part, using corresponding structure as taught herein. For example, the components described above in conjunction with the “module for” components of FIGS. 9A and 9B also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary non-transitory storage medium is coupled to the processor such that the processor can read information from, and write information to, the storage medium. In the alternative, the storage medium may be integral to the processor (e.g., cache memory).

Accordingly, it will also be appreciated, that certain aspects of the disclosure can include a non-transitory computer-readable medium embodying a method for initiating handover preparation of a subset of a plurality of cells in a wireless communication network for a mobile device, such as described above with reference to processes 300, 350, 400, 450, 500, 600, 700, and 800.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of initiating handover preparation of a subset of a plurality of cells in a wireless communication network for a mobile device, the method comprising:
determining, by a serving cell of the mobile device, a first set of candidate cells of the plurality of cells in the wireless communication network;
obtaining, by the serving cell, at least one data selected from the group consisting of backhaul performance data, historical mobility data, and historical handover data, wherein:
the backhaul performance data indicates a backhaul performance of each of the candidate cells included in the first set of candidate cells,
the historical mobility data indicates which of the plurality of cells have previously served the mobile device, and
the historical handover data indicates a number of instances that the mobile device or other mobile devices were previously handed off to each respective candidate cell of the first set of candidate cells;
adding at least one candidate cell of the first set of candidate cells to the subset of the plurality of cells based on the at least one data; and
generating and sending a handover request message from the serving cell to each cell included in the subset of the plurality of cells to initiate handover preparation of the mobile device from the serving cell.

2. The method of claim 1, wherein determining the first set of candidate cells includes adding cells included in a neighbor relation table of the serving cell to the first set of candidate cells.

3. The method of claim 1, further comprising receiving a message from the mobile device that indicates a received signal strength (RSS) for each cell identified in the first set of candidate cells, wherein adding the at least one candidate cell to the subset of the plurality of cells is based on a respective RSS of the candidate cell.

4. The method of claim 1, further comprising sending a request to a server included in the wireless communication network for the backhaul performance data of one or more of the candidate cells.

5. The method of claim 1, further comprising receiving periodic updates from a server included in the wireless communication network, wherein the periodic updates include the backhaul performance data of one or more of the candidate cells.

6. The method of claim 1, further comprising monitoring messages exchanged with a respective cell including messages exchanged for handover with that cell in order to obtain the backhaul performance data.

7. The method of claim 1, wherein adding the at least one candidate cell to the subset of the plurality of cells comprises adding the at least one candidate cell to the subset of the plurality of cells if backhaul performance data of the at least one candidate cell indicates backhaul performance that is below a performance threshold.

8. The method of claim 1, wherein the historical mobility data further indicates an amount of time that the mobile device was previously served by at least one of the plurality of cells.

9. The method of claim 1, further comprising storing the historical handover data, at the serving cell, wherein the stored historical handover data indicates a number of instances that the mobile device or the other mobile devices were previously handed off to each respective candidate cell of the first set of candidate cells from the serving cell, wherein adding the at least one candidate cell to the subset of the plurality of cells is based on the historical mobility data and on the historical handover data.

10. The method of claim 1, further comprising:
handing off the mobile device to one of the cells included in the subset of the plurality of cells; and
updating the historical handover data based on which of the cells the mobile device is handed off to.

11. The method of claim 10, further comprising updating the historical handover data based on the historical mobility data of the mobile device and which of the cells the mobile device is handed off to.

12. The method of claim 9, further comprising updating the historical handover data based on information included in messages exchanged during incoming and outgoing handovers.

13. The method of claim 1, further comprising identifying one or more identified handover patterns of the mobile device based on at least one of the historical mobility data and the historical handover data, wherein adding at least one candidate cell of the first set of candidate cells to the subset of the plurality of cells is based on at least one of the one or more identified handover patterns or one or more stored handover patterns maintained at the serving cell.

14. The method of claim 13, wherein identifying the one or more identified handover patterns comprises:
identifying a first sequence of previous serving cells of the mobile device from the historical mobility data; and
identifying cells from the historical handover data that were selected for handover a threshold number of times for sequences that match the first sequence.

15. The method of claim 13, further comprising:
handing off the mobile device to one of the cells included in the subset of the plurality of cells; and
updating the one or more stored handover patterns based on which of the cells the mobile device is handed off to.

16. An apparatus for use in a serving cell to initiate handover preparation of a subset of a plurality of cells in a wireless communication network for a mobile device, the apparatus comprising:
memory adapted to store program code; and
a processing unit coupled to the memory to access and execute instructions included in the program code to direct the serving cell to:
determine a first set of candidate cells of the plurality of cells in the wireless communication network;
obtain at least one data selected from the group consisting of backhaul performance data, historical mobility data, and historical handover data, wherein:
the backhaul performance data indicates a backhaul performance of each of the candidate cells included in the first set of candidate cells,
the historical mobility data indicates which of the plurality of cells have previously served the mobile device, and
the historical handover data indicates a number of instances that the mobile device or other mobile devices were previously handed off to each respective candidate cell of the first set of candidate cells;
add at least one candidate cell of the first set of candidate cells to the subset of the plurality of cells based on the at least one data; and
generate and send a handover request message from the serving cell to each cell included in the subset of the plurality of cells to initiate handover preparation of the mobile device from the serving cell.

17. The apparatus of claim 16, wherein the program code further comprises instructions to monitor messages exchanged with a respective candidate cell of the first set of candidate cells, including messages exchanged for handover with that cell, in order to obtain the backhaul performance data.

18. The apparatus of claim 16, wherein the program code further comprises instructions to add the at least one candidate cell to the subset of the plurality of cells if their respective backhaul performance data indicates backhaul performance that is below a performance threshold.

19. The apparatus of claim 16, wherein the program code further comprises:
instructions to store the historical handover data, at the serving cell, wherein the stored historical handover data indicates a number of instances that the mobile device or the other mobile devices were previously handed off to each respective candidate cell of the first set of candidate cells from the serving cell; and
instructions to add the at least one candidate cell to the subset of the plurality of cells based on the historical mobility data and on the historical handover data.

20. The apparatus of claim 16, wherein the program code further comprises:
instructions to hand off the mobile device to one of the cells included in the subset of the plurality of cells; and
instructions to update the historical handover data based on which of the cells the mobile device is handed off to.

21. The apparatus of claim 20, wherein the program code further comprises instructions to update the historical handover data based on the historical mobility data of the mobile device and which of the cells the mobile device is handed off to.

22. The apparatus of claim 20, wherein the program code further comprises instructions to update the historical handover data based on information included in messages exchanged during incoming and outgoing handovers.

23. The apparatus of claim 16, wherein the program code further comprises:
instructions to identify one or more identified handover patterns of the mobile device based on at least one of the historical mobility data and the historical handover data; and
instructions to the at least one candidate cell to the subset of the plurality of cells based on at least one of the one or more identified handover patterns or one or more stored handover patterns maintained at the serving cell.

24. The apparatus of claim 23, wherein the instructions to identify the one or more identified handover patterns comprises instructions to:
identify a first sequence of previous serving cells of the mobile device from the historical mobility data; and
identify cells from the historical handover data that were selected for handover a threshold number of times for sequences that match the first sequence.

25. An apparatus for initiating handover preparation of a subset of a plurality of cells in a wireless communication network for a mobile device, the apparatus comprising:
means for determining, by a serving cell of the mobile device, a first set of candidate cells of the plurality of cells in the wireless communication network;
means for obtaining, by the serving cell, at least one data selected from the group consisting of backhaul performance data, historical mobility data, and historical handover data, wherein:
the backhaul performance data indicates a backhaul performance of each of the candidate cells included in the first set of candidate cells,
the historical mobility data indicates which of the plurality of cells have previously served the mobile device, and
the historical handover data indicates a number of instances that the mobile device or other mobile devices were previously handed off to each respective candidate cell of the first set of candidate cells;
means for adding at least one candidate cell of the first set of candidate cells to the subset of the plurality of cells based on the at least one data; and
means for generating and sending a handover request message from the serving cell to each cell included in the subset of the plurality of cells to initiate handover preparation of the mobile device from the serving cell.

26. The apparatus of claim 25, further comprising means for adding the at least one candidate cell to the subset of the plurality of cells if their respective backhaul performance data indicates backhaul performance that is below a performance threshold.

27. The apparatus of claim 25, further comprising:
means for identifying one or more identified handover patterns of the mobile device based on at least one of the historical mobility data and the historical handover data; and
means for adding the at least one candidate cell of the first set of candidate cells to the subset of the plurality of cells based on at least one of the one or more identified handover patterns or one or more stored handover patterns maintained at the serving cell.

28. A non-transitory computer-readable medium including program code stored thereon for initiating handover preparation of a subset of a plurality of cells in a wireless communication network for a mobile device, the program code comprising instructions to:
determine a first set of candidate cells of the plurality of cells in the wireless communication network;
obtain at least one data selected from the group consisting of backhaul performance data, historical mobility data, and historical handover data, wherein:
the backhaul performance data indicates a backhaul performance of each of the candidate cells included in the first set of candidate cells,
the historical mobility data indicates which of the plurality of cells have previously served the mobile device, and
the historical handover data indicates a number of instances that the mobile device or other mobile devices were previously handed off to each respective candidate cell;
add at least one candidate cell of the first set of candidate cells to the subset of the plurality of cells based on the at least one data; and
generate and send a handover request message from a serving cell to each cell included in the subset of the plurality of cells to initiate handover preparation of the mobile device from the serving cell.

29. The non-transitory computer-readable medium of claim 28, further comprising instructions to add the at least one candidate cell of the first set of candidate cells to the subset of the plurality of cells if their respective backhaul performance data indicates backhaul performance that is below a performance threshold.

30. The non-transitory computer-readable medium of claim 28, further comprising instructions to:
identify one or more identified handover patterns of the mobile device based on at least one of the historical mobility data and the historical handover data; and
add the at least one candidate cell to the subset of the plurality of cells based on at least one of the one or more identified handover patterns or one or more stored handover patterns maintained at the serving cell.
